(19) United States
(12) Patent Application Publication
(10) Pub. No.: US 2002/0041921 A1
(43) Pub. Date: Apr. 11, 2002

(54) Methods of improving shelf life of eggs

(76) Inventors: L. John Davidson, Atkinson, NH (US); Myron A. Wagner, Wilmington, DE (US)

Correspondence Address: James P. Murphy, McAndrews, Held & Malloy, Ltd., 500 West Madison Street, 34th Floor, Chicago, IL, 60661, US

(21) Appl. No.: 09/954,462

(22) Filed: Sep. 14, 2001

Related U.S. Application Data
(63) Continuation-in-part of application No. 09/613,832, filed on Jul. 11, 2000.
(63) Continuation-in-part of application No. 09/197,573, filed on Nov. 23, 1998.
(60) Provisional application No. 60/271,726, filed on Feb. 28, 2001.
(60) Provisional application No. 60/271,746, filed on Feb. 28, 2001.

(51) Int. Cl. A23B 5/00

(52) U.S. Cl. 426/298; 426/614

(57) ABSTRACT

A method of extending the safe shelf life of shell eggs is taught. Eggs are pasteurized by heating eggs until a central portion of the yolks of the eggs is at a temperature between 128° F. to 138.5° F. That temperature is preferably maintained and controlled for times within parameter line A and parameter line B of FIG. 1 and sufficient that any Salmonella species present in the yolk is sufficiently reduced but insufficient that an albumen functionality of the egg measured in Haugh units is unacceptably affected. The pasteurized eggs are further processed to extend the shelf life of the eggs, and to substantially reduce re-contamination of the eggs. Eggs entering the pasteurization process are initially treated with an anti-bacterial agent. The bath itself is fortified with an anti-bacterial agent of food quality and periodically fortified. Processed eggs are treated with an anti-bacterial agent, and sealed. The sealant material provides a barrier substantially eliminating re-contamination. A safe egg is provided having a shelf life of 6 months or more.

### RELATED APPLICATIONS

This application claims priority to, and is a continuation of Provisional Patent Application serial Nos. 60/271,726 and 60/271,746, filed Feb. 28, 2001, and a continuation-in-part of Non-Provisional application Ser. No. 09/613,832, filed Jul. 11, 2000 and Ser. No. 09/197,573 filed Nov. 23, 1998.

### FEDERALLY SPONSORED RESEARCH OR DEVELOPMENT

[Not Applicable]

### MICROFICHE/COPYRIGHT REFERENCE

[Not Applicable]

### TECHNICAL FIELD OF THE OF THE INVENTION

The present invention relates to poultry shell eggs of overall improved food safety quality and to shell egg pasteurization and post-pasteurization sterilization procedures that prevent contamination of and extend the shelf life of shell eggs.

### DEFINITIONS

Functionality or Functional Properties: Eggs contribute to the volume, structure, texture, and keeping quality of baked products. The coagulation of egg proteins during heating brings about the thickening of custards and pie fillings and the binding of pieces of food together as in loaves or croquettes. When eggs are whipped, the proteins form elastic films and incorporate air that provides the leavening and volume needed in such products as angel food cakes, souffles, sponge cakes, and meringues. The foam structure of these products is made rigid by coagulation of the protein during baking. The elasticity of egg protein films is also important in popovers and cream puffs; the protein films stretch when steam is produced during baking and later coagulate to form the framework of the product. Lipoproteins of the yolk are good emulsifying agents. They make it possible to disperse the oil in the other ingredients and thereby contribute to the consistency of mayonnaise and salad dressings and the structure of cream puff shells.

Whole eggs are used in sponge and layer cakes, bread, and rolls. Yolks are used in mayonnaise and salad dressing, sweet goods, doughnuts, and cakes in which more yellow color is desired. Whites are used in angel food cakes, meringue toppings, puff pastry, white pound cakes, layer cakes, cupcakes, certain candies, and a number of premixed products.

The extent to which the functional properties are affected by pasteurization is determined by testing the performance of the eggs under conditions in which damage is readily observed. For purposes herein, “without substantial loss of functionality” means that an albumen functionality of the egg measured in Haugh units is substantially less than the albumen functionality of a corresponding unpasteurized in-shell egg. Further, “not substantially less” means that any differences are not of practical significance. Also, the egg weight, the yolk index, the yolk strength, the angel cake test, the sponge cake test, and frying, scrambling and boiling characteristics of the present pasteurized egg are not substantially less than a corresponding unpasteurized in-shell egg. Likewise, the present pasteurized egg can substantially maintain those characteristics when stored at about 40° F. to 45° F.

Pasteurization (or Pasteurization Process) Temperature: The temperature at which a pasteurization medium (air or other gas, water, oil, or other fluid, etc.) is maintained for an RPT such that any infectious or other microorganisms present in an egg are destroyed preferably to 5 logs, but at least to an extent sufficient to ensure that the egg is safe for human consumption, on the shell of the egg and throughout and in the furthermost reaches of the egg interior including the egg yolk. Typical pasteurization temperatures range from 126° F. to a temperature approaching but less than 200° F.

EqT: The point at which all particles throughout the mass of a shell egg reach equilibrium with the selected pasteurization medium temperature and the point at which RPT begins. EqT time is the time required to obtain EqT of an egg.

Real Process Time (RPT): That part of the TPT after all particles throughout the mass of a shell egg have reached a selected pasteurization temperature enabling pasteurization for liquid whole shell eggs.

Total Process Time (TPT): That total length of time for which an egg is heated beginning with the egg at an initial preprocessing temperature and ending when the application of heat to the egg is terminated. TPT equals EqT time plus RPT.

Throughout the mass of an egg: encompasses all matter in the shell of an egg and within the shell.

Temperatures are often expressed hereinafter in the form xxx to yyy° F. (.+−.z° F.). This is to be interpreted as a temperature range in which the lower limit is a nominal xxx° F. with a tolerance of .+−.z° F. and the upper limit is a nominal yyy° F. with a tolerance of .+−.z° F.

### BRIEF DESCRIPTION OF THE DRAWINGS

FIG. 1 is a graph showing the correlation between the temperatures of a central portion of the yolk of an egg during the pasteurization process and the log (base 10) of time at which that central portion of the yolk of the egg dwells at such temperatures in order to meet a given pasteurization standard. That graph also shows permissible limits of deviation from that correlation, indicated by parameter lines A and B.

FIG. 2 is a flowchart of the process for creating and maintaining a liquid pasteurization bath with anti-bacterial agent added.

FIGS. 3a and 3b are flowcharts of an overall preferred egg pasteurization procedure utilizing the invention disclosed and claimed herein.

### BACKGROUND OF THE INVENTION

For many years minimum food safety processing standards for various commodities have been promulgated and enforced by the United State Department of Agriculture (“USDA”) or Food and Drug Administration (“FDA”). While long enforced for liquid whole eggs and egg products of a wide variety, based upon minimum standards of pasteurization processing, food safety standards have only recently been established for shell eggs. Indeed, as a review of the prior art identified in this specification has shown, only recently has technology been available for successfully pasteurizing shell eggs to acceptable standards, that is, to standards equaling USDA and/or FDA guidelines established for other egg products.

Shell eggs are an important commodity affording the consumer many nutritional advantages unparalleled by any other food product. These advantages include very favorable costs per nutritional unit of food value, convenience of preparation, gastronomic enjoyability, culinary usefulness, and availability.

It has long been known that some shell eggs contain infectious organisms such as Salmonella which, from a food safety standpoint, is of primary concern. Techniques for improving the food safety of shell eggs by destroying these infectious microorganisms have been proposed. However, aside from those effective for external sanitation, only recently have any ever been successfully employed. Instead, processing, handling, and other aspects of egg production have been emphasized in an effort to indirectly reduce the magnitude of the problem.

Moreover, even though pasteurization procedures are now known, as taught by Cox et al. U.S. Pat. Nos. 5,939,118 and 5,589,211 and Davidson U.S. Pat. Nos. 6,165,538 and 5,843,505 (each of which is incorporated herein by reference), eggs may be re-contaminated after they have been pasteurized. Eggs may become recontaminated by various means because egg shells are porous and will accept small micro-organisms through the shell pores. Furthermore, although the USDA and/or FDA mandate safe handling procedures for raw eggs which include cold storage, eggs are not often handled in complete conformity commercially, or by individual consumers. Often times, eggs are left sitting out in warm environments in ambient conditions in which bacteria can flourish. Thus, a need exists to preserve the safe quality of pasteurized eggs, and all eggs, and extend the shelf life of eggs.

Awareness and concerns regarding infectious organisms in the yolk of a shell egg have been slow in developing. Both awareness and concerns have been amplified increasingly over the past decade as a result of numerous outbreaks of food poisoning irrefutably attributable to such yolk-associated organisms.

Increasingly, concerns over the safety of eggs consumed as a food illuminate the issue of transovarian infection developed deep inside the egg as it is formed in the oviduct. In addition, infectious organisms are known to penetrate the pores of shells and perhaps even the vitelline membranes of eggs, contaminating deeper proteins including the yolks. Also, for reasons not entirely clear, diseased hens are now known to excrete microorganisms inside the egg. The offending microorganism currently identified with this problem is Salmonella enteritidis (S. enteritidis).

Salmonella are small, gram negative, nonsporing rod bacteria. They are indistinguishable from Escherichia coli (E. coli) under the microscope or on ordinary nutrient media. All species and strains are currently presumed to be pathogenic for man.

As a disease organism, Salmonella produces a variety of illnesses depending on the species. S. typhimurium, which translates to “Salmonella from Typhus Mary”, needs no other explanation. S. typhi causes enteric fever. S. paratyphi type A and type B cause a syndrome which is similar to but milder than typhus. Over 2,000 other species of Salmonella are known. The number increases yearly.

Among the most common vehicles for food poisoning caused by Salmonella are eggs. Widespread publicity on illnesses and deaths attributed to contaminated eggs containing S. enteritidis in Europe over the past few years has reportedly resulted in a reduction in egg consumption. In some distinct marketing areas the reduction has been estimated to be as great as 50 percent. The problem is being perceived in Europe and in the United States as chronic, spreading, and a major public health challenge. Nevertheless, in the United States alone, approximately 240,000,000 dozen eggs are still consumed annually.

Little is known about virology inside the egg. It has long been and is still believed by some that shell eggs are sterile inside the shell. Needle puncture samples of the inside of an egg including both yolk and white taken under aseptic conditions usually do demonstrate a negative plate count when cultured. Nevertheless, it is well known that, when eggs are broken in quantity, they immediately demonstrate significant gross populations of infectious microorganisms. It is not unusual to find plate counts ranging from several hundred to many thousands, even when the surface of the egg shells have been cleaned of filth and washed in the best antiseptics known to food science. The occurrence of S. enteritidis inside the shell egg is now also well documented. See, e.g., STADELMAN AND COTTERILL Egg Science and Technology (3^{rd} ed.), at pp. 75-95.

One source of infection arises from the fact that egg shells have numerous pores which permit the egg to breathe. Pore holes vary in size. When the egg is laid, those holes come into contact with organic refuse in the cage. It is very likely that some microbes contacting the egg are of a size which allows them to fit through the pores. Once inside, the microbes are not uniformly spread around the interior of the egg but are retained in small patches on the inner shell membrane, which has yet smaller pores than the shell.

Washing a dirty egg may actually spread microbes more evenly, increasing contamination through greater surface contact with entry pores in the egg shell. When the eggs are cracked, the shell membranes may be ripped and torn loose. And, when the shells are subsequently emptied, the eggs may be peppered with this stored inoculum in addition to airborne bacteria.

Also, as egg temperatures vary, there is active and ongoing gas and vapor exchange between the yolk and white via the vitelline membrane, between the white and the inside of the shell via the outer and inner shell membranes, and also between the shell and the outside environment.

Finally, as discussed above, eggs can be, and frequently are, contaminated by transovarian infection. The extent of this problem is still not known. Thus, an egg may be unsafe to eat even if there is no transport of harmful microorganisms from the exterior of the egg to its interior. Worse yet is when both of the egg infecting mechanisms—pore penetration and transovarian infection—are at work.

U.S. Pat. No. 4,808,425 issued Feb. 28, 1989 to Swartzel et al. elaborates on the USDA standards for pasteurizing liquid eggs, summarizes the disclosures of many references, identifies resources relative to egg pasteurization, and adequately points out many of the problems associated with available techniques for making liquid but not shell eggs of safer food quality. Swartzel et al. employ a conventional pasteurization technique—time at temperature—to treat liquid egg products. The products are contacted against a heated surface at high temperatures; i.e., above 140° F. (60. degree. C.) for short durations of less than 10 minutes. This approach is not applicable to a shell egg.

The minimum time at temperature processing mandated by USDA standards produces liquid eggs which are safe to eat because all particles have been exposed to RPT; and, if the liquid eggs are carefully processed, an at least acceptable degree of functionality and other valued properties can be retained. Standards for shell eggs are lacking because, until recently, a reliable time at temperature technique for making shell eggs safe to eat has not existed. Other researchers had focused their attention on time and temperature treatments for devitalization of vital shell eggs. To a much lesser extent, pasteurization of shell eggs to improve food safety quality has been considered.

Funk (Stabilizing Quality in Shell Eggs, Missouri Agricultural Experimental Station, Research Bulletin no. 362 and Maintenance of Quality in Shell Eggs by Thermostabilization, Missouri Agricultural Experimental Station, Bulletin no. 467) and Murphy and Sutton (Pasteurization of Shell Eggs to Prevent Storage Rot and Maintain Quality—a Progress Report of Experimental Work, Misc. Publication no. 3317, Department of Agriculture, New South Wales, Australia) purported to preserve shell eggs by briefly heating the eggs for 15 or 16 minutes at temperatures ranging from 130. degree. to 135.9° F. (54.4. degree. C. to 57.7. degree. C.) and from 129.2. degree. to 136.4° F. (54. degree. C. to 58. degree. C.). Irrespective of the starting temperature of the shell egg to be processed, these prior art processes cannot possibly provide a Salmonella free or Salmonella reduced inner egg. Neither can they achieve equivalents of the minimum requirements established by the USDA for processing liquid whole eggs.

On the contrary, because the internal temperatures reached near or in the center of the yolk are not high enough to destroy Salmonella and other infectious microorganisms, these prior art techniques, irrespective of how employed or combined, cannot meet accepted minimum standards for other egg products and by and large can only attain temperatures in the yolk within the times suggested which are in a range that will cause substantial increases of any food poisoning infections present therein. Within a very narrow range of those parameters, processed eggs may or may not become more infected, depending on the specific conditions at hand. In other instances a shell egg carrying a minor, non-lethal infection in the yolk can by use of such methods deteriorate markedly and become a very significant health risk, if not a toxic food.

New serotypes of infectious organisms continue to develop. Increased production, mass handling, and widespread distribution of food products continue to increase the risks of food poisoning. Food poisoning incidents related to eggs are not uncommon and may even be increasing. Almost all food products have well developed standards of processing for ensuring food safety. This is not true for shell eggs, for which standards of pasteurization have only recently been developed. The primary reason for this lack of food safety pasteurization standards as required for all other egg products is undoubtedly attributable to the lack of knowledge of an efficacious process for making shell eggs safer to eat. In practice, known processes such as the one discussed above and proposed by Funk are inefficacious and either fail completely to achieve any meaningful benefits or are highly likely if not certain to result in products with substantially increased health hazards from food poisoning.

As a result of the demand for functional, pasteurized shell eggs, methods were developed, using temperature and time to pasteurize a shell egg throughout its entire mass with a degree of effectiveness equaling or even exceeding that obtained by employing the USDA minimum and protracted standards for liquid whole eggs. This provided a safe egg by reducing to an acceptable level the possibility that the subsequent ingestion of the processed egg might cause food poisoning, typically an illness consisting of gastroenteritis and fever lasting for several days but a deadly threat if a person in one of the susceptible categories identified above is infected.

At the same time, these novel shell egg pasteurization techniques do not unduly compromise the integrity, functionality, or quality of the egg. For example, U.S. Pat. No. 5,589,211 to Cox et al. and U.S. Pat. No. 6,165,538 to Davidson teach methods of making poultry shell eggs safer to eat by, inter alia, heating the eggs within a temperature range to destroy microorganisms in the eggs.

But, once pasteurized, an egg may be prone to further contamination through, for instance, contact with surrounding air or processing equipment or other transportation and handling equipment. Therefore, processes are needed for maintaining the quality of the egg after the pasteurization process, by further preventing infection or re-infection of eggs after they are pasteurized and prior to consumption.

Moreover, processing eggs according to the Cox '211 Patent, or the Davidson '505 Patent or the Davidson '538 Patent, may utilize a liquid pasteurizing bath. Because eggs shells are porous, some of the liquid in the bath will likely be drawn inside the egg shell either by general osmosis or because of the a vacuum created between the egg contents and the egg shell- caused by contracting and expanding of the egg shell. If the bath liquid contains any live bacteria or bacterial spores, that bacteria can inadvertently enter the egg. Therefore, the more bacteria-free the liquid bath, the better the likelihood that such liquid will not cause any increase in bacteria in the shell egg. Thus, providing a more bacteria-free pasteurization bath provides for a better pasteurized egg, with a longer shelf life.

Further, in an accepted process of pasteurizing eggs, after the eggs have been pasteurized and/or at least partially cooled, the eggs may be sealed with a sealant material which seals the pores of the egg shells so as to avoid recontamination of eggs during handling of the eggs, especially during the handling of the eggs on machinery for packaging the pasteurized eggs. While these sealant materials may take a variety of forms, including but not limited to polyvinyl alcohol solutions, cellulosic solutions, acetate polymer solutions, and the like, a usual form is simply a wax.

It has, however, been discovered that known sealants do not completely prevent recontamination of the eggs and a substantial percentage of pasteurized eggs are recontaminated, especially with rot-producing bacteria, during the usual handling of the eggs subsequent to pasteurization. As an example, commercial production of eggs economically may require handling equipment which utilizes suction cups and negative pressure to pick up and move large quantities of eggs. The nature of such devices is that they can suck up bacteria from just one egg, and spread it to multiple eggs in a brief time. So, special procedures are required to ensure that no bacteria exists on the equipment, ands that no contaminants from a single egg are transferred to many eggs by use of mass production equipment.

In another pasteurizing process, eggs may be heated and subsequently held at selected temperatures for an appropriate time to effect pasteurization, followed by rapid cooling (or quenching) of the treated eggs. This final step ensures that, as they are cooled, the treated eggs pass rapidly through that portion of the temperature spectrum favoring bacterial growth. If quick cooling is not employed, any remaining harmful bacteria may multiply and negate some or all of the effects of the time-at-temperature treatment, especially if the eggs are allowed to remain for any significant time in a temperature zone favoring microbial growth. For this reason, natural cooling of treated eggs to ambient conditions or even cold storage conditions can allow new growth of any remaining unkilled microorganisms to occur.

But, even rapid cooling can have serious drawbacks since microorganisms in the ambient environment of the treated eggs can recontaminate the egg surface and be drawn back inside through shell pores by negative pressure generated inside the shell as the egg cools. Therefore, the more rapid the cooling, the cleaner the environment, and the more sterile the cooling environment, the better. However, achieving an acceptably sterile post-pasteurization environment, if even possible, is very expensive.

One possible way to avoid recontamination of the pasteurized eggs by contact with organisms in the ambient environment, by handling, and by other mechanisms, is to package the egg in an impervious film or other sealant just after pasteurization, and preferably prior to cooling. Examples of appropriate films and package materials are those fabricated of polyethylenes and polyvinylchlorides. Other acceptable packaging which can be used to prevent recontamination includes composite films and readymade, food approved proprietary packaging such as Cry-O-Vac®, Seal-A-Meal®, and the like.

The egg may be processed in the package and the package aseptically sealed after processing, but before cooling; or the package may be sealed prior to pasteurization processing, this being followed by cooling to ambient or a refrigeration temperature. Among the advantages of processing the egg in packaging is that no recontamination can occur during steps requiring cooling or handling. The packaging of eggs before processing, particularly by the dozen or in the other multiples, offers many other advantages including the ability to use modified atmosphere gases such as carbon dioxide, nitrogen, and mixtures as a package filler to: prevent spoilage; reduce breakage during processing; make handling, the automation of production, and standardization of egg moisture levels easier; and facilitate the addition and the diffusion into the egg of process aids such as organic acidification agents including citric, lactic, benzoic, and ascorbic acids, to name but a few. Eggs processed in individual packaging may be slipped into more-or-less standard egg cartons while packages in which eggs are processed in multiples may be wrapped or placed in cardboard sleeves to present the packaged appearance commonly expected by the consumer.

When eggs are packaged together, the packages of eggs may be filled with carbon dioxide, nitrogen, or a carbon dioxide/nitrogen mixture before pasteurization or after pasteurization and before cooling and then sealed. Upon cooling in the sealed package, the gas will be drawn in through the pores in the egg shell and the shell and vitelline membranes to provide a stabilizing, deterioration inhibiting gas inside the egg.

Wrapping of eggs can be expensive, however, on a per egg basis. Thus, a need exists to seal eggs efficiently, safely, and economically. Moreover, if eggs are sealed individually, breakage of one egg in a packaged group of eggs will not contaminate the remaining, unbroken eggs. Further, egg processors have for many years used egg oil to coat and to protect the eggs. It is believed, however, that use of oil on the eggs may not work to prevent contamination. In fact, in tests done, eggs coated with egg oil were exposed to water and dye. In each test, the dye entered the egg through the dye, showing that egg oil does not adequately seal the pore of the eggs.

The present invention, the preferred embodiments of which are explained further below, provide solutions to these concerns.

### SUMMARY OF THE INVENTION

It is known to pasteurize eggs by heating eggs to within a predetermined range of temperatures for a predetermined range of times, to provide a safe egg without significant loss of functionality, as taught in Cox '211 and Davidson '505 and Davidson '538. However, the present invention provides a safer, higher quality egg and efficient process for producing a safer egg by preventing further contamination of pasteurized eggs by either pathogenic or rot-producing bacteria.

As noted above, it has been found that, to reliably and controllably pasteurize an egg without substantial loss of functionality, the temperature of the yolk should be in the range of 128° F. to 138.5° F. While pasteurization can be achieved with yolk temperatures as low as 126° F., this temperature is near the minimum temperature to kill Salmonella and variables, such as particular egg histories and sizes/grades, etc., can affect results.

Thus, for practical application of the invention, the central portion of the yolk should be at a temperature of 128° F. or higher. This means, of course, that when a heat transfer medium as described above is used, that medium must be at a temperature of at least 128° F., since, otherwise, that heating medium would not be capable of heating the central portion of the yolk to at least 128° F. On the other hand, while the central portion of the yolk should not reach a temperature greater than about 138.5° F., the temperature of the heating medium can be higher than that temperature, since there will be a temperature differential between the temperature of the heating medium and the central portion of the yolk until an equilibrium temperature is established. However, it has also been found that a higher temperature of the heating medium should not be too high, since, otherwise, the chances of decreasing the functionality of the albumen before pasteurization occurs, especially near the shell, increases. For this reason, it is preferable that the medium is heated to temperatures no greater than 142° F. Although, when pasteurization below 5 logs is desired for example, higher temperatures for shorter times may be employed.

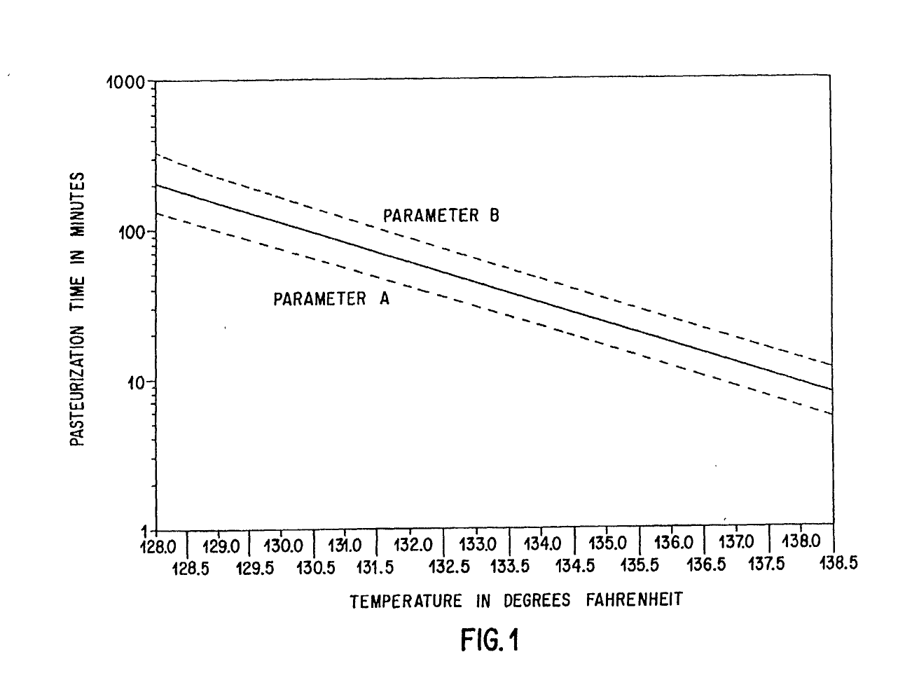

The medium may be heated to more than one temperature during the pasteurization process. For example, the medium may be heated to a higher temperature for part of the pasteurization dwell time of the yolk, and then cooled to lower temperatures no less than 126° F. for the remainder of the portion of the dwell time of the yolk. There are certain advantages to heating to such higher temperatures and then cooling to such lower temperatures during the pasteurization process, in that the total time required for pasteurization is decreased. At the higher yolk temperatures, within parameter lines A and B of FIG. 1, the chances of decreased albumen functionality are increased. Therefore, in order to decrease processing time and the chances of decreased functionality, the heating medium may be heated to higher temperatures for part of the pasteurization and then heated to a lower temperature for the remaining part of the pasteurization, consistent, of course, with the yolk temperature being within the range within the appropriate dwell times. If such different temperatures of the heating medium are used, it is preferable that the higher temperatures are between about 136° F. and 139° F. and the lower temperatures are between about 131° F. and 135° F.

The most preferred method in the foregoing regard is that of using one or more higher heating medium temperatures, e.g. 138° F., until the yolk temperature reaches a target value, e.g. 134° F., and then decreasing the temperature of the medium to that target temperature, e.g. 134° F., and maintaining that reduced medium temperature until the dwell time specified by FIG. 1 is reached. Several or more different medium temperatures may be used, so long as the resulting temperatures and dwell times of the yolk fall within the required parameter lines. This provides some latitude in fine adjustment of the process for optimum pasteurization and retention of functionality of the egg even with varying egg input and input egg conditions.

Further, it has been found that an egg will be more reliably pasteurized by pasteurizing the egg in a liquid bath containing an anti-bacterial agent. While pasteurizing an egg in a liquid bath, the bath temperature is controlled closely to achieve a pasteurizing temperature for a predetermined time, but while preventing loss of functionality of the egg itself. During this process, some of the liquid of the bath invariably will seep into the inside of the egg shell. This is because the egg shell is porous, and when surrounded by liquid will accept some of that liquid.

If the liquid which seeps into the egg is contaminated to any extent with any harmful bacteria, that bacteria may contaminate the egg and affect the otherwise pasteurized egg. There on occasion may be a pasteurized egg which has some forms or level, albeit safe forms or level, of bacteria within the shell. It has been discovered that pasteurizing eggs in a bath which includes a predetermined mixture of anti-bacterial agents will help further prevent re-contamination of pasteurized eggs. Further, it has been found that pasteurizing eggs in a bath fortified with an anti-bacterial agent can reduce bacteria within the shell of the egg that the pasteurization without the anti-bacterial agent would not otherwise achieve.

Acceptable antibacterial agents include any agent that is colorless, odorless, tasteless and safe for human consumption. We have found that a preferable anti-bacterial agent is a quaternary ammonia salt (QAS), or hydrogen peroxide, H₂O₂, or ozone. However, any appropriate anti-bacterial agent may be employed which (1) is safe for human consumption in acceptable dilution, and (2) retains antibacterial properties during pasteurization. Further, preferably the agent should be inexpensive enough to allow for the intended use and result without making the process commercially unacceptable.

It has been further discovered that recontamination of pasteurized eggs can also be significantly reduced when the sealant material (wax will be discussed hereinafter but only as an example) contains an antibacterial agent. While that antibacterial agent can take many forms, and the particular antibacterial agent is not critical to the invention, a very useful antibacterial agent is one of the known antibacterial quaternary ammonium salts. This is because that antibacterial agent is easily dissolvable in water and in wax, is approved for food use, is relatively inexpensive, and the use thereof has no known adverse side effects to humans. Therefore, the invention will be described in connection with quaternary ammonium salts.

### DETAILED DESCRIPTION OF THE INVENTION

It is now known that eggs can be effectively pasteurized without substantial loss of functionality by heating the eggs precisely within certain time and temperature parameters. One such method includes heating the eggs in a liquid bath. It has been found however, that, after being pasteurized, eggs are vulnerable to re-contamination by bacteria or other micro-organisms entering the porous shell. It has also been found that eggs pasteurized in a liquid bath may inadvertently accept some of the liquid bath through the porous shell of the egg. If any live bacteria or spores are present in the bath, it may also be inadvertently drawn into the egg, adversely affecting the egg.

It has been discovered that providing a liquid pasteurization bath composed of a 35% solution of H₂O₂ with water safely and effectively eliminates any inadvertent entry of bacteria into the eggs. Hydrogen Peroxide is approved by the FDA as a safe additive for treatment of eggs against bacteria. In the preferred mixture solution, it has been found to be very effective in killing Salmonella and other egg-infecting organisms. Moreover, H₂O₂ is safe for human consumption at appropriate levels. Therefore, if trace amounts of H₂O₂ are drawn into some of the pasteurized eggs, the H₂O₂ not only helps to eliminate any harmful bacteria within the egg, but is safe and not noticeable to the consumer. In exemplary tests in a 250-gallon pasteurizing tank, tests showed consistent reduction to almost zero of bacteria using 1¼ ounces of Hydrogen Peroxide in a heated bath.

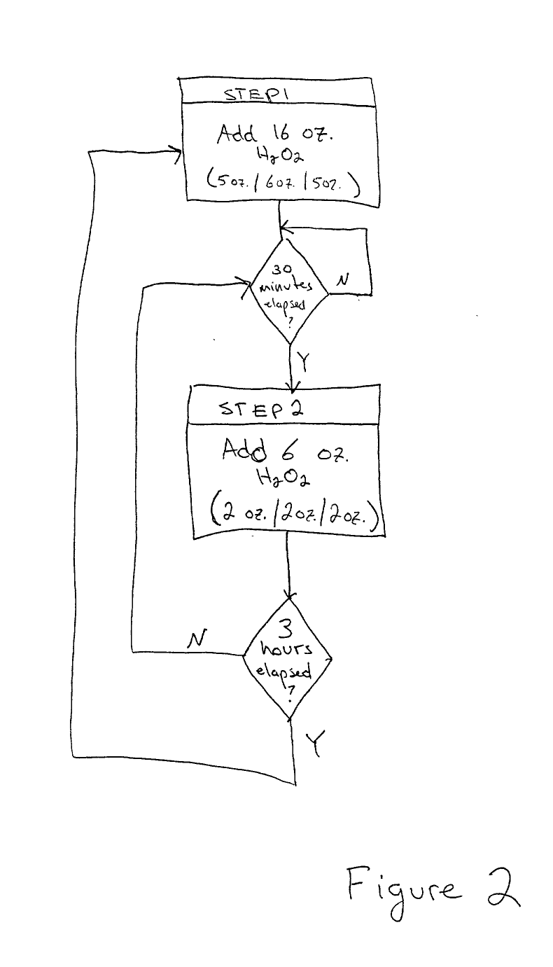

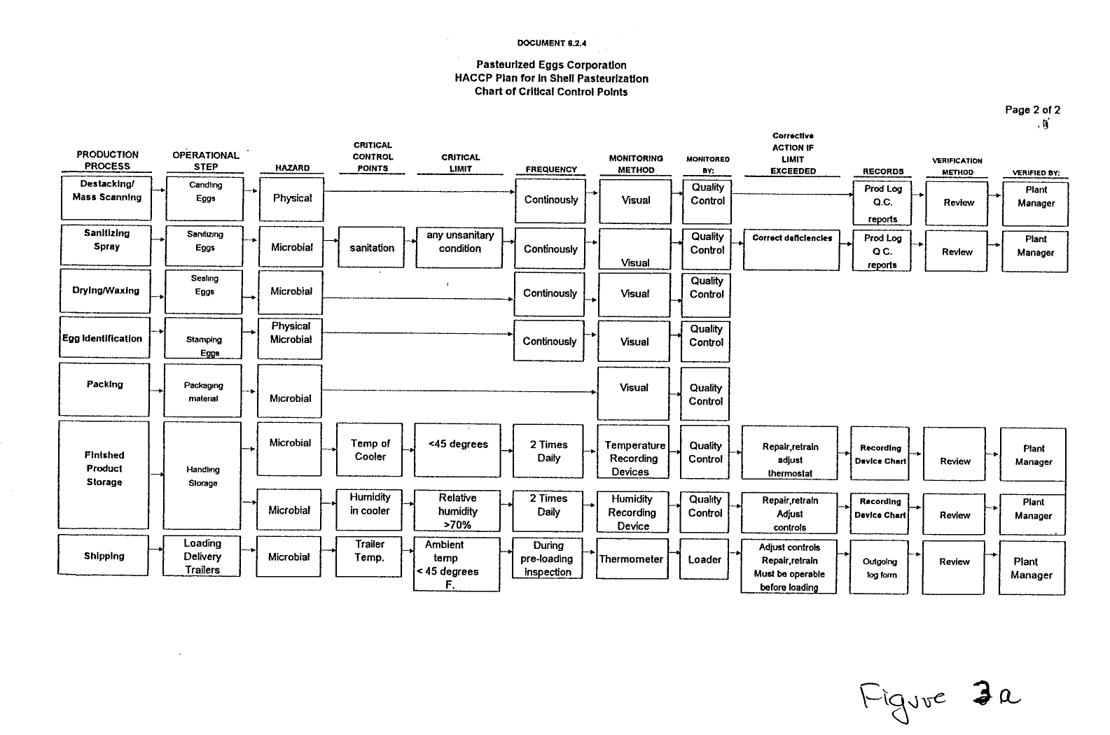

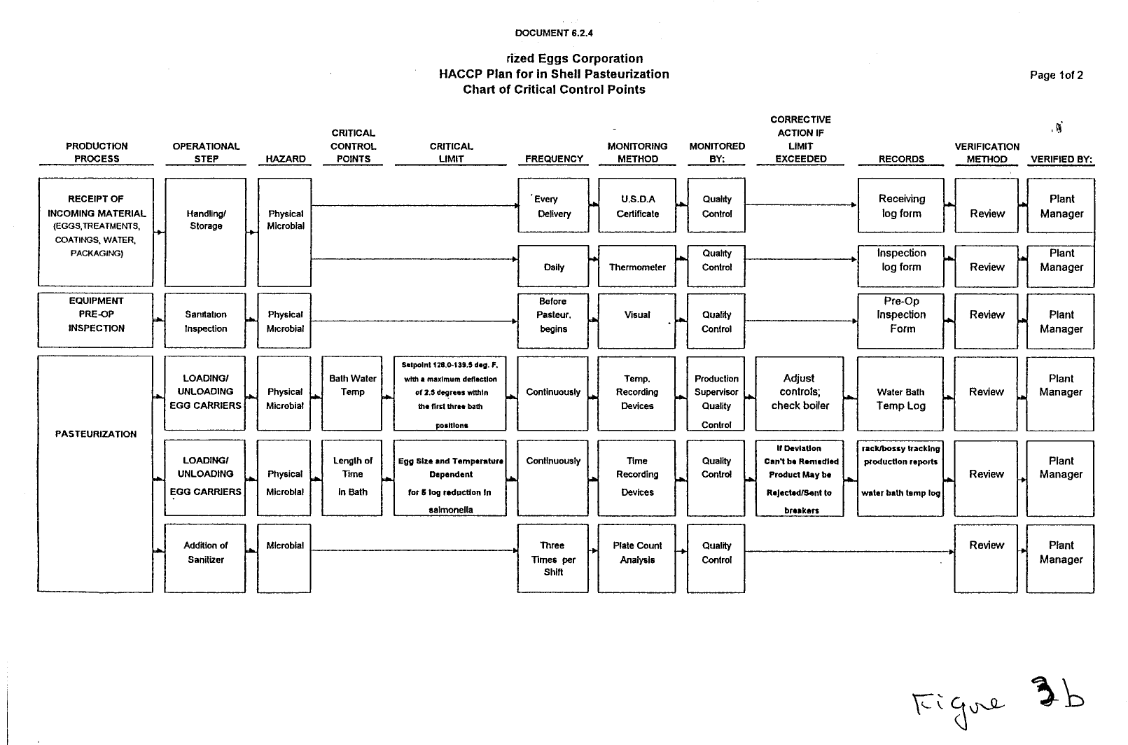

In a preferred process, as shown in FIG. 2, food grade hydrogen peroxide in a 35% solution is applied to the liquid bath periodically to maintain appropriate levels. Because hydrogen peroxide deteriorates gradually in solution, and this deterioration is accelerated by both the heat of the bath and the contact with the metal tank, to maintain its effectiveness, it must be periodically fortified within the bath. In a pasteurizer having a volume of approximately 3000 gallons, it has been found that between 8 and 25 ounces of hydrogen peroxide is sufficient. We found that the following procedure works best in a bath tank generally comprising three zones including a front loading zone, a middle zone and a rear exit zone. First, step 1, add 16 oz. of hydrogen peroxide 30 minutes before pasteurization (while water is still cold), by putting 5 oz. in to the initial egg loading position, 6 oz. into the middle of the tank, and 5 oz. into the rear or unloading position. Next, step 2, 6 oz. should be added every half hour, for 3 hours, in equal amounts across the tank. Next, step 3, after three hours of processing, an additional 16 oz. should be added, in the same amounts and locations as in step 1. Next, step 4, repeat step 2 until another 3 hours have passed. Then, repeat step 3. Following these steps ensures maintenance of proper levels of hydrogen peroxide.

It has been found that the appropriate hydrogen peroxide level should be maintained most importantly at the beginning of the bath, where microbial infusion into the bath will be most dense, caused by the raw untreated eggs. Further, to neutralize this effect, it is also helpful to wash the eggs before entering the bath with a hydrogen peroxide solution. This peremptory step further reduces the level of bacteria on the eggs and, therefore, entering the bath.

Next, eggs which exit the pasteurization bath must be cooled. As described above, the eggs may by cooled in ambient air, or in a chilled bath. As further described above, during cooling, the pasteurized eggs are susceptible to contamination by bacteria in the surrounding air, or within a chilled bath liquid. To eliminate this risk, or at least reduce it to safe levels, the pasteurized egg may be treated with an anti-bacterial agent, and sealed.

We have found that treating the eggs upon exit of the pasteurizing bath with a 200 ppm solution of QAS with water will help to prevent any contamination during cooling. A solution of between 10 and 200 ppm is believed suitable, while 200 ppm is officially approved maximum concentration. Further, hydrogen peroxide or chlorine solution will also be adequate. In a preferred application, the QAS solution is first heated to a temperature of not greater than about 130° F. The preferable temperature is between 100° F. and 115° F. to match the core temperature of the pasteurized eggs. This application of the QAS solution further eliminates the possible re-contamination of the eggs.

The eggs may then be sealed individually or in groups. To seal the eggs in groups, a film or other wrapping material may be utilized to cover the eggs. To seal eggs individually, a film or other wrapping material may be used, also, although that may become economically unfeasible. A more economically feasible alternative to seal individual eggs is a sealant which can be applied as a liquid. Suitable sealant materials include wax materials. However, wax alone also does not adequately prevent re-contamination of pasteurized eggs, at least because part of the sealant may enter the egg through the porous shell.

It has been found that use of a paraffin wax/water/anti-bacterial agent solution and application process is effective in preventing re-contamination of pasteurized eggs. In a preferred embodiment, a paraffin wax emulsion is preferably heated to a temperature of about 120° F. This temperature may vary, but must be sufficiently high to melt the wax to a consistency which lends itself to be readily applied to egg shells, and preferably should be within a range of about 90° F. to 130° F. A preferred wax solution is 10 gallons of water to 8 gallons of paraffin wax emulsion to 3.75 ounces QAS. The wax sealant mixture is then maintained at a temperature preferably just above the temperature of the pasteurized eggs to which the sealant will be applied. As the pasteurized eggs finish the pasteurization process and anti-bacterial spray application, the wax solution is sprayed onto the eggs to coat each egg entirely.

Moreover, it has been found that the wax sealant provides even greater protection when mixed with water from which the iron has been removed. It is believed that organisms that induce rot in eggs thrive on iron. If the material contacting the egg shell contains iron which may seep into the egg, the threat of rot is increased. To substantially eliminate this threat, it has been found that iron may be removed from the wax emulsion. Iron can be removed from the water being mixed with the wax with a known cascading de-ionizer system, prior to mixing.

Preferably immediately upon exiting the bath, the heated wax/water/QAS sealant solution is applied to the warm eggs. The shorter the interval between the eggs exiting the bath and a sealant applied, the less prone the eggs will be to re-contamination. Preferably, the sealant is applied via an atomizer-type sprayer commercially available. The spraying of the wax with the QAS coats the entire outer surface of the eggshell and therefore seals the pores. The QAS sealant solution adheres to the egg shell, and repels any bacteria that may exist in the ambient air or liquid the eggs will then be exposed to. With the sealant on the eggs, it has been found that the eggs will maintain a shelf life of six months or more when stored at temperature of about 45° F. or lower. In addition, the hot wax with QAS will slightly migrate through the eggshell and into the space between the inner eggshell and the egg membrane. The QAS will therefore kill any bacteria that might have penetrated the eggshell during removal of the eggs from the flats and while the eggs were on the conveyor, even though those apparatuses were sprayed with the solution of QAS.

During pasteurization, eggs exit the pasteurizer generally at or above the minimum pasteurization temperature, i.e. 128° F., and are ultimately cooled to below such temperature, so as to cease pasteurization and any further loss of functionality of the eggs. As noted in a pending disclosure in regard to COOLING PASTEURIZED EGGS IN AMBIENT AIR, the eggs will continue to be pasteurized until they cool below about 128° F. During this cooling down time, whether in ambient air or chilled bath or otherwise, recontamination of eggs can occur. Moreover, while the eggs cool, a small vacuum may be created within the shell egg as the contents contract. When this happens, as explained above, any surrounding air or liquid is prone to be drawn into the egg through its porous shell. If the sealant is applied at or above that of the egg temperature, the sealant will not promote the contraction any more than is necessary, and will prevent the vacuum from contributing to re-contamination, at least until the sealant is completely applied. The application will further not promote cracking of the egg shell. Once the sealant is applied, the egg is no longer reasonably susceptible to bacterial recontamination. As such, application of a sealant comprised in part of an anti-bacterial agent prevents virtually any recontamination of the pasteurized egg, and significantly extends the shelf life of the egg. The present processes will produce a pasteurized egg which has a shelf life, when stored at or below about 45° F., of at least six months or more.

Further, applying an anti-bacterial sealant to eggs has a further advantage. When handling eggs, as any consumer knows, some eggs may crack and/or break open completely. When this occurs, that egg is again exposed to the surrounding atmosphere. Moreover, because eggs are normally packaged by the dozen for consumers and in other quantities for other purposes, when an egg breaks the entire group of eggs is exposed to the contents of that broken egg. So, if an egg breaks during shipment, and the individual eggs are not sealed, the other eggs within the package are prone to any contaminants that that egg may provide. If individual eggs are sealed, however, the unbroken eggs remaining within the packaged group are not prone to re-contamination. This is important to shippers and grocers who cannot afford to lose entire quantities of eggs due to a single broken egg. Thus, sealing eggs according to the present invention provides a safer egg with a long shelf life, and reduces significant cost in egg handling.

In any event, after the eggs are removed from the pasteurizing bath, mechanical grippers will generally lift the eggs off of the flats carrying the eggs through the pasteurizing bath and deposit the eggs on a conveyor (usually a roller conveyor) for further processing, either before or after a sealant is applied. The mechanical grippers are known, and common grippers are made by Diamond Manufacturing, among others. As is generally known, the mechanical grippers use suction to adhere the eggs to a suction cup to transport the eggs. The suction cups generally suck in surrounding air when gripping the egg. The suction cups then exhaust air when releasing the eggs. During this process, any bacteria in the air that is sucked in or expelled will be applied directly to each egg shell at or near that suction cup. Moreover, and significantly, the suction cups themselves directly contact the egg shells. And, because of the number of eggs be handled, each suction cup will contact perhaps thousands of eggs in every production run. As such, any contaminants in the air or on the equipment will quickly be transferred to many eggs.

In the present invention, contamination from the egg handling equipment is virtually eliminated. By the present invention, a water solution of anti-bacterial agent, preferably QAS, is sprayed on the mechanical grippers which remove the eggs from the flats and on the roller conveyor so as to decontaminate both the mechanical grippers for removing the eggs and the rollers on which the eggs move. This will largely avoid recontamination of the eggs as they are cooled and moved from the pasteurizing bath. As above, any antibacterial agent being safe for human consumption may be employed.

According to the present invention, a solution of QAS is provided. A manifold was designed to provide the QAS solution in conjunction with the suction cup apparatus. The manifold provides the means to transfer the QAS solution to each suction cup. A negative pressure atomizer, as is known generally, applies the QAS solution to each suction cup. Each time an egg is picked up and each time an egg is released, the manifold delivers an atomized QAS solution spray through the manifold and to each suction cup and each egg to prevent any contaminants from reaching and/or adhering to the eggs, or the suction cup equipment.

As another preventative step, the egg handling equipment should be de-contaminated periodically with QAS or other antibacterial agent. Preferably, all equipment coming in contact with the eggs is de-contaminated by fogging the air with a 200 ppm QAS solution. More preferably, the QAS solution is heated to approximately 120° F. prior to applying it to the equipment. This sanitizing of the egg handling equipment is the final measure which, when followed, will ensure a safe egg with a substantially extended shelf life.

Of course, it should be understood that various changes and modifications to the preferred embodiments described herein will be apparent to those skilled in the art. Other changes and modifications, such as those expressed here or others left unexpressed but apparent to those of ordinary skill in the art, can be made without departing from the spirit and scope of the present invention and without diminishing its attendant advantages. It is, therefore, intended that such changes and modifications be covered by the following claims.

What is claimed is:

1. A method of increasing the safety of an in-shell chicken egg comprising:
a. providing a liquid bath containing an anti-bacterial agent and water;
b. heating the bath to a temperature above 126° F.;
c. placing the egg in the bath until a central portion of a yolk of the egg is controlled within a temperature range of 126° F. to 200° F.;
d. maintaining that controlled yolk temperature range for times, (i) sufficient that a Salmonella species present in the egg yolk is reduced in amount such that the egg is pasteurized but (ii) insufficient that an albumen functionality of the egg measured in Haugh units is substantially less than the albumen functionality of a corresponding unpasteurized in-shell chicken egg.

2. The method of claim 1 wherein the bath containing an anti-bacterial agent and water is comprised of water and hydrogen peroxide.

3. A method of providing an in-shell chicken egg resilient to re-contamination comprising:
a. removing a substantially pasteurized egg from a pasteurizing medium which egg is at a temperature at or above ambient temperature and which egg is substantially pasteurized without substantial loss of functionality;
b. applying a sealant to the egg, wherein the sealant comprises a wax emulsion at a temperature above the temperature of the egg.

4. The method of claim 3 further comprising applying an anti-bacterial agent to the egg before applying the wax sealant to the egg.

5. The method of claim 3 wherein the wax emulsion comprises a mixture of paraffin wax, water and a quaternary ammonia salt.

6. A method of prolonging the shelf life of an in-shell poultry egg comprising:
a. providing a liquid bath containing an anti-bacterial agent and water;
b. heating the bath to a temperature above 126° F.;
c. placing a plurality of eggs in the bath until a central portion of a yolk of each of the eggs is controlled within a temperature range of 126° F. to 200° F.;
d. maintaining that controlled yolk temperature range for times, (i) sufficient that a Salmonella species present in the egg yolk is reduced in amount such that the egg is pasteurized but (ii) insufficient that an albumen functionality of the egg measured in Haugh units is substantially less than the albumen functionality of a corresponding unpasteurized in-shell chicken egg;
e. removing the plurality of eggs from the bath; and
f. applying a sealant to substantially all of each of the plurality of eggs.

7. The method of claim 6 further comprising applying an anti-bacterial agent to the plurality of eggs prior to placing the plurality of eggs in the bath.

8. The method of claim 6 further comprising heating the bath to a plurality of temperatures, each of which is above 126° F.
